(19) United States
(12) Patent Application Publication
(10) Pub. No.: US 2011/0140466 A1
(43) Pub. Date: Jun. 16, 2011

(54) ABSORBER ELEMENT FOR IMPACT ENERGY

(75) Inventor: Alois Hillen, Blankenrath (DE)

(73) Assignee: ZF FRIEDRICHSHAFEN AG, Friedrichshafen (DE)

(21) Appl. No.: 13/059,443

(22) PCT Filed: Aug. 11, 2009
(86) PCT No.: PCT/DE09/50041

§ 371 Date: Feb. 17, 2011

(30) Foreign Application Priority Data
Aug. 20, 2008 (DE) 10 2008 041 373.9

(51) Int. Cl. B60R 19/26

(52) U.S. Cl. 293/132

(57) ABSTRACT

An absorber element, positioned between an object to be protected and an impact element, for absorbing impact energy. The absorber element comprises a flange plate (1) and a deformation body (2, 3, 4) comprising a hollow cylindrical inner tube (2), a telescopic tube (3) with a section (5) which is formed inside-out, and an outer cup (4) which are interlaced in such a way so that a section (7) of the inner tube (2), which needs to be connected with the impact element, is positioned outside of the telescoping tube (3) and the outer cup (4), and that the inner tube (2) extends, at its side which faces the flange plate, into the outer cup (4), as well and at least into an opening of the telescoping tube (3). The inner tube (2) is bonded with an opening (8) of the telescoping tube (3) and, in the area of its entry into the outer cup (4), bonded with the outer cup (4).

This application is a National Stage completion of PCT/EP2009/050041 filed Aug. 11, 2009, which claims priority from German patent application serial no., 10 2008 041 373.9 filed Aug. 20, 2008.

### FIELD OF THE INVENTION

The invention relates to an absorber element to absorb energy generated during a collision. It is related to an absorbing element, called crash box, which is preferably provided at a position between the body of a motor vehicle and a cross member of a bumper which serves the purpose, during an impact with an object which needs to be protected such as a motor vehicle, to at least partially absorb the initiated energy by deformation of the absorber element and its parts.

### BACKGROUND OF THE INVENTION

It has long been known, during impact with an object, that the created energy can be absorbed through the conversion to a deformation work. With that goal, motor vehicles are designs with crumple zones, for instance. Also the bumpers, as impact protectors or impact elements, serve for absorption of the generated forces during impact of motor vehicles. The absorption of the forces is achieved by a certain construction of the bumpers with elastic material and also through the method by which they are attached to the motor vehicle chassis. It hereby became a common business practice, in the automotive industry, to position specially designed absorber elements (crash boxes) between the vehicle chassis and the bumper. These absorber elements have a design and geometry which are targeted to possibly absorb a large part of the energy, created during an impact, by deformation of the absorber elements.

A generic absorber element is described, for instance, in DE 10 2004 036 929 A1 under the title “Impact Absorber Element.” The configuration in this publication comprises, starting at a flange plate into the inner part of a hollow longitudinal beam of the vehicle chassis, continuing to an outer tube and an inner tube which is guided by the outer tube, and positioned through a head-end plate at the bumper. Hereby, a narrowing shape is designed into a section of the outer tube in which one end of the inner tube is guided, which hereby has a corresponding narrowing shape. During an impact, the inner tube is pressed into the outer tube, whereby a wider section of the hollow cylindrical inner tube, opposite the narrowing, meets the narrowed cross-section of the outer tube. Hereby, the originally wider section of the inner tube gets deformed in a way that its diameter adjusts itself to the inner diameter of the narrow section of the outer tube. Hereby, the force created by the impact, in the axial direction from the bumper to the inner tube, is absorbed. The absorber element is, as described in this publication, however, quite effective for absorption of the generated forces of the impact. The disadvantage is, however, that the inner tube, in order to meet the requirements of the intended function of the absorber element, has to have a relatively large diameter. It hereby results in a relatively large mass for the absorber element which is a disadvantage in view of the material cost of manufacturing and, on the other hand, it is contrary to the intentions of the automotive industry to reduce the mass of motor vehicles with respect to an ecological perspective. It is also a disadvantage, with regard to the manufacturing process, that the inner tube and the outer tube of the damper configuration possess, in comparison, a rather complicated geometric shape.

### SUMMARY OF THE INVENTION

The task of the invention is to present an alternative solution for a generic absorber element. Hereby, the respective absorber element shall have, in view of the reduction of the manufacturing cost, be designed in a way that it possesses a largely linear absorption pattern over a possibly larger deformation distance and also has a relatively simple construction process. Preferably and through a suitable design of the absorber element, an additional reduction of its mass, compared to the solutions presented in the state of the art, shall be accomplished.

The task is solved through an absorber element with the characteristics of the main claim. Advantageous, additional embodiments or expansions, respectively, are presented in the dependent claims.

To solve the task, the proposed absorber element, which needs to be positioned between an object to be protected and an impact element, comprises at least of a flange plate and a deformation body. The absorber element needs to be attached to the object to be protected, by means of a flange plate which covers a hollow space and opposite to the flange plate, to the axial end of the deformation body, with the impact element. The object which needs to be protected can be, for instance, in accordance with presentations in the state of the art, a motor vehicle whereby the absorber element needs to be inserted between the vehicle chassis and, in this case, an existing bumper of the motor vehicle. Hereby, the absorber element is mounted with its flange plate, preferably in a direction of a flange plate, to a bare longitudinal beam of the motor vehicle. The particular existing hollow space of the bare longitudinal beam is hereby covered by the flange plate.

In accordance with the invention, the deformation body comprises of a hollow cylindrical inner tube, a telescopic tube with a section formed inside-out, and an outer cup and are partially interlaced in a way so that a section of the inner tube, to be connected with the impact element, is positioned outside of the telescoping tube and the outer cup, and the inner tube, with its side facing the flange plate, extends into the outer cup and it continues at least into the opening of the telescoping tube. Hereby is created that the telescoping tube is also partially positioned in the outer cup part and extends with its inside-out formed section, through which a double-wall section of the telescoping tube, to the outside of the outer cup whereby it is open in a direction of its extension to the outer cup. The inner tube is firmly bonded to the opening, facing in the direction of the impact body, of the telescoping tube and is firmly bonded with the outer cup, in the area where it enters into the outer cup.

The positioning of the parts, which represent the deforming body of the absorber elements, are designed in a way that the end of the outer cup, facing away from the impact element, is connected at the a flange plate here with its open side, extending to the outside outer cup and in a direction of the aforementioned end of the outer cup and its inside-out section of the telescoping tube.

Mainly due to the simple geometry of the inner tube, the invented absorber element has, by comparison, a simple construction. A special advantage of the invented absorber element is the fact that the kind of design of the deforming body, especially through the combination of the outer cup and of the telescoping tube is already presenting, to a certain extent, a deformed cup, can represent much more consistent characteristics with regard to the absorption pattern of the absorber element, where the parameter of the force entered over the deformation distance is almost linear over a larger deformation distance and is largely parallel to the abscissa, which represents the amount of the deformation.

It is basically possible to design the outer cup as well as the telescoping tube cylindrically, which means with a constant cross-section. However, to enable the outer cup and the telescoping tube to deform, in case of an impact in the main axial direction and the resulting force for the conversion of the impact energy into deformation work, through a folding of the outer cup on one side and the reverse deformation of the respective telescoping tube, also a cup shaped part already deformed for the first time during the production, on the other side, it would be required, in this case, to design in the area of its firmly bonded connection with the inner tube larger collars which extend radial to the inside. The outer cup and also the telescoping tube would then need a comparatively large diameter which would, however, be rather unfavorable in view of the desired weight reduction. Thus, in an especially preferred embodiment, the outer cup and/or the telescoping tube are, therefore, conically enlarged in the direction of the flange plate and its cross section. Hereby, their respective deformation has an advantage during an impact.

In view of the design of the flange plate, two basic embodiments of the invented absorber elements are possible. In one of the embodiments, the flange plate is provided between the outer cup, at its end which is facing away from the impact element and the inside-out folded section of the telescoping tube, meaning an additional plate is constructed. Hereby, the respective plate is firmly bonded, with the side facing the impact element, with the outer cup and is firmly bonded, on its sides which are facing away from the impact element, with the telescoping tube by the rim of the inside-out formed section. The telescoping tube extends, in this embodiment, through a constructed opening in the flange plate into the outer cup. As already mentioned, a firmly bonded connection exists with the outer cup, on one hand, between each of the opposing sides of the flange plate which is additionally inserted and, on the other hand, a firmly bonded connection exists with the telescoping tube. The outer cup and the telescoping tube are, therefore, connected to each other, meaning indirectly through the additionally inserted plate.

The other embodiment is designed in a way that the flange plate is designed with a collar which extends toward the outside, at the outer cup at the side which is facing away from the impact element and/or with a collar, in the end of the inside-out formed section which is formed to match the telescoping tube, extending transverse to the longitudinal axis of the absorber element. Hereby, the outer cup or the telescoping tube, or both named parts of the information body, can optionally have a respective collar shape.

Due to the fact that the last described embodiment of the absorber element does not have an additional flange plate and that it is replaced by parts of the outer tube and/or the telescoping tube, an additional advantageous reduction in the manufacturing cost or logistics cost, respectively, is achieved through the saving of a part.

In an advantageous embodiment enhancement of the invented absorber element, the inner tube extends beyond the opening of the telescoping tube and continues up to the inside-out folded section of the telescoping tube. Hereby, the absorber element can absorb, in an advantageous way, larger transverse forces. With an absorber element, which has a cross section that expands conically in the direction of a flange plate, this advantage can be even increased via a conical enlargement of the inner tube in the section where it extends into the corresponding telescoping tube. Advantageously, the outer surface of the inner tube, in the section which extends into the telescoping tube, is mostly and closely located adjacent to the inner surface of the telescoping tube.

The absorber element can, dependent on requirements or individual confines of the installation space, be designed in different ways with regard to the connection of the inner tube with the impact element. In accordance with a provided embodiment, a support plate, which closes up the inner tube, is provided for the connection with the impact body at the end of the inner tube, facing away from the flange plate, which is firmly bonded with the inner tube and which extends transverse or is tilted with reference to the longitudinal axis of the inner tube. By means of this support plate, the absorber element or its inner tube, respectively, can be mounted, for instance, by attaching it to the impact element, for instance, to the transverse beam of the bumper of a motor vehicle.

The invented absorber element can be either comprised of steel or, dependent on the respective required cost-weight compromise, aluminum. The firm bonding between the parts of the absorber element is preferably achieved by a welded connection.

### BRIEF DESCRIPTION OF THE DRAWINGS

The invention is explained further in the following, based on embodiment examples. The associated drawings show embodiments of an absorber element which is positioned in a motor vehicle between the body and the bumper. Details shown in:

FIG. 1a: a first, possible embodiment of the invented absorber element in a cross section view,

FIG. 1b: the absorber element in accordance with FIG. 1a in a perspective presentation,

FIG. 2: an embodiment of the absorber element, slightly modified as compared to the embodiment of FIG. 1a,

FIG. 3: the absorption pattern of the absorber element presented in a graphical characteristic.

### DETAILED DESCRIPTION OF THE PREFERRED EMBODIMENTS

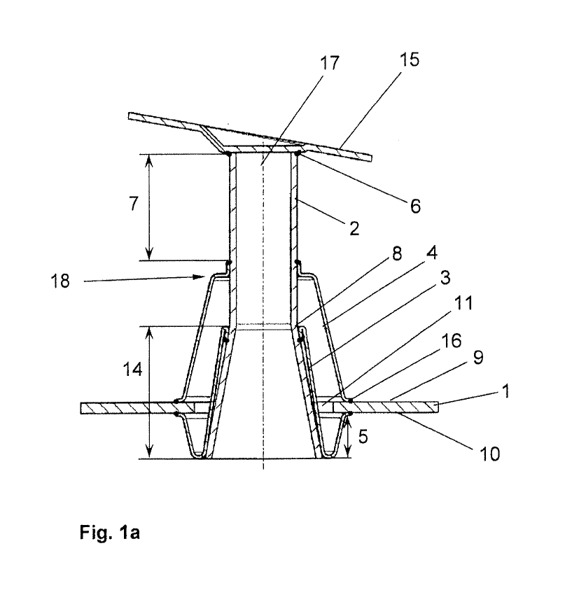

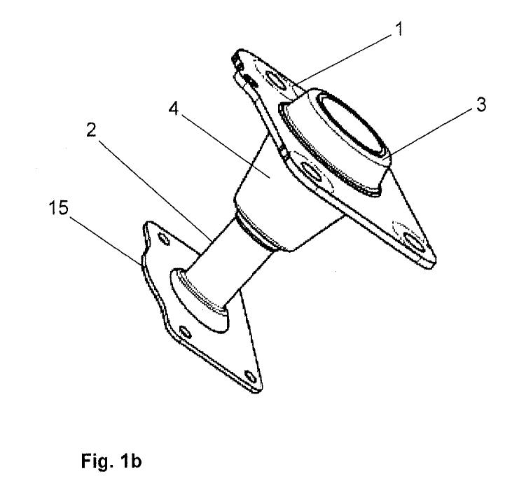

FIG. 1a shows, in a cross section view along the longitudinal axis 17, a possible embodiment of the invented absorber element. The presented absorber element is substantially constructed by the towering deformation body 2, 3, 4 which is towering from the flange plate 1. The deformation body 2, 3, 4, following the basic idea of the invention, comprises of a hollow, cylindrical inner tube 2, an outer cup 4 and a telescoping tube 3 with its inside-out folded section 5 which, as seen in the drawing, are partially interlaced in a special way. By means of the flange plate 1, the provided absorber element, which is intended to be applied to a motor vehicle, is mounted to a hollow profile, transverse beam of the motor vehicle. Hereby, the flange plate 1 covers the hollow area of the transverse beam in the direction of the flange plate, whereby the profile of the transverse beam which borders the hollow area, referenced in the orthogonal direction to the longitudinal axis 17, engages with the inside-out formed section of the telescoping tube free at the flange plate 1, in an insignificant distance, so that the flange plate 1, with almost its entire surface, simultaneously supports itself at the head end of the transverse beam. At the opposite side, with reference to the flange plate 1, of the absorber element or its deformation bodies 2, 3, 4, respectively, as shown in the drawing of the embodiment, a support plate 15 is provided at the respective axial end 6 of the inner tube 2 and is connected to the inner tube 2 by means of a welded seam. The transverse beam of a bumper will be attached to this support plate 15 during the intended installation of the absorber element.

The drawing clearly shows that the interlacing of the parts which create the deforming body 2, 3, 4, namely, the inner tube 2, the outer cup 4 and the telescoping tube 3, is constructed in a way so that the inner tube 2, on the side of the support plate 15 which needs to be connected with the impact body or bumper, respectively, extends out from the telescoping tube 3 and the outer cup 4 over a section 7 while, on the other side, meaning the opposite side which is toward the flange plate 1, extends into the outer cup 4 and continues hereafter into the telescoping tube 3. At the same time, the telescoping tube 3 extends, through a recess 11 in the flange plate 1, partially into the outer cup 4. The inner tube 2 is firmly bonded, in each section of its entry into the outer cup 4 or into the telescoping tube 3, respectively, with the previously named parts by means of a welded connection. The outer cup 4 is attached to the side 9 of the flange plate 1, facing the impact element (not shown here) and the telescoping tube 3 is attached to the side 10 of the flange plate 1 via a welding connection. Thus, the outer cup 4 and the telescoping tube 3 are also connected with each other by the inserted plate which is the flange plate 1. In the shown exemplary embodiment of the absorber element, the outer cup 4 as well as the telescoping tube 3 are conically enlarged in the direction toward the flange plate 1. The inner tube 2, over its section 14 which extends into the telescoping tube 3, is also conically designed whereby the course of its cross section largely follows the cross section of the telescoping tube 3 and the outer surface of the inner tube 2 is almost completely attached to the inner surface of the telescoping tube 3. By this construction, larger transverse forces can also be absorbed by the absorber element.

In case of an impact in the axial direction, meaning in the direction along the longitudinal axis 17 via the not shown impact body and the provided support plate 15 which is connected with this impact body, the induced impact energy into the absorber element is mainly absorbed by movement of the inner tube 2 in the direction of the flange plate 1 and hereby, the outer cup 4, which is connected with the inner tube 2, is deformed whereby the outer cup 4, by a present fold 18 which is the connection point with the inner tube 2, is folded to the inside. Thus, the impact energy is converted into work needed for the deformation and is therefore absorbed. By movement of the inner tube 2 in the direction of the flange plate 1, the telescoping tube 3 is also deformed, largely at the same time as the outer cup 4. In particular, it can be compared with the cone shaped, thus also called a cone cup, the outer cup 4, as it can also be viewed as a cone cup but which has already been deformed once (during manufacturing), and which now reverses the deformation through the motion, in the direction of the flange plate 1, with its connected opening 8 with the firmly bonded inner tube 2. In total, the inner tube 2 is more rigidly designed, in view of the deformation, then the outer cup 4 or the telescoping tube 3 so that the inner tube 2 does not exhibit any particular deformation, during an impact, but is only moved toward the direction of the flange plate 1.

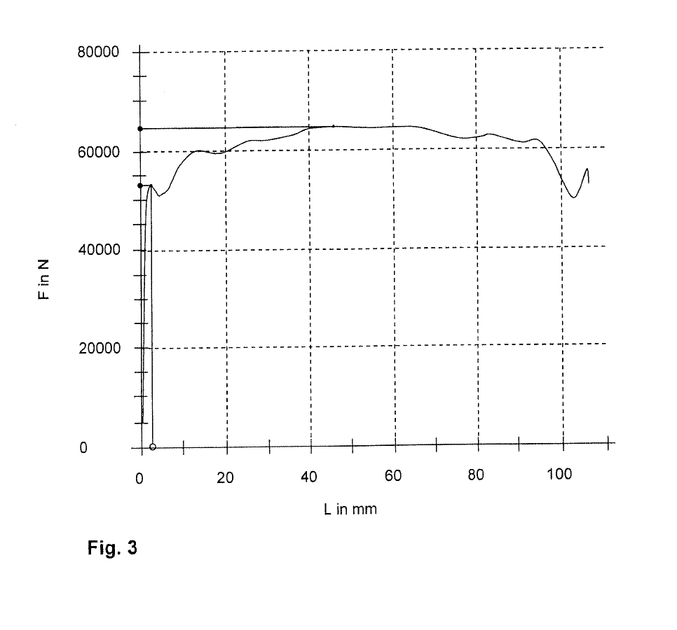

Due to the construction and design of the body formation, to a certain extent with the serial positioned cone cups (outer cup 4 and telescoping tube 3) and thus the forced deformation pattern of the absorber element, a fairly constant characteristic curve, as shown in FIG. 3, can be achieved. As can be seen in FIG. 3, the generated insertion force in the system, during deformation, is largely constant over a wide range of deformation so that the characteristic curve, over a larger section, is parallel to the abscissa.

In FIG. 1b, the embodiment shown in FIG. 1a is once again shown in a perspective presentation. Again, the axial symmetrical deformation body 2, 3, 4 and the plates 1, 15 which are positioned at the ends, namely, the flange plate 1 for the attachment of the absorber element to the vehicle chassis and the support plate 15 for the attachment to the transverse beam of a bumper, can easily be recognized. By the plates 1, 15, the absorber element can be attached, on one side, to the longitudinal beam of a vehicle chassis and, on the other side, to a transverse beam of a bumper. In the case of an impact, the inner tube 2 of the deformation body 2, 3, 4 initially moves back toward the flange plate 1, by initially folding the outer cup 4, followed by the telescoping tube 3, out of the open telescoping tube 3, on the opposite side of the flange plate 1, and into the available hollow space (not shown here) which is a designated installation behind the flange plate of a longitudinal beam of a motor vehicle.

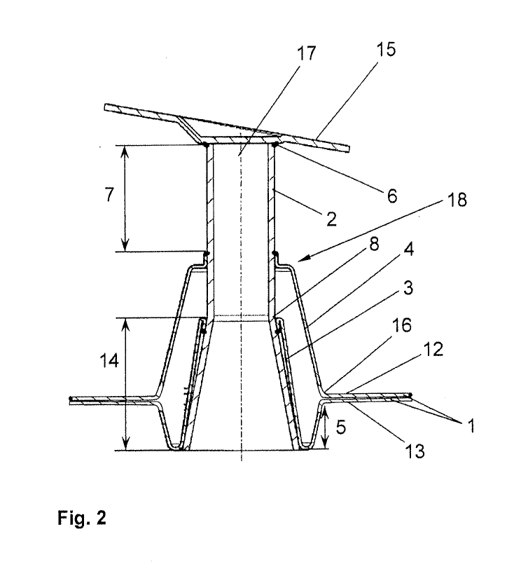

FIG. 2 shows, compared to FIG. 1a, a slightly modified embodiment of the invented absorber element. It is basically a slightly more cost-effective variation of the absorber element as compared to the embodiment in FIG. 1a because, in this case, a separately positioned flange plate 1, between the opposite end 16 of the support plate 15 of the outer cup 4 and the inside-out folded section 5 of the telescoping tube 3, has been eliminated. In this embodiment, rather the flange plate 1 is designed as an integral part of the deformation body 2, 3, 4, whereby its outer cup 4, on the side facing away from the flange plate 1, and the telescoping tube 3 which is integrally formed to the inside-out folded section 5, each have a collar 12, 13 which extends transverse to the longitudinal axis 17 and radial toward the outside. When creating the flange plate 1 here, the outer cup 4 and the telescoping tube 3 are connected to one another and the collar sections via a welding joint. In view of the fact that the flange plate 1 is supported by the longitudinal beam during a dedicated installation of the absorber element, changes of the deformation pattern of the absorber element, as compared to the embodiment in FIG. 1a, are hardly expected but, however, a significant cost reduction can be achieved.

### REFERENCE CHARACTERS

1 Flange Plate
2, 3, 4 Deformation Element
   2 Inner Tube
   3 Telescoping Tube
   4 Outer Cup
5 Inside out or folded to the outside, respectively, section
6 End of the Inner tube
7 Section
8 Opening
9, 10 Side of the Flange Plate
11 Recess
12, 13 Collar
14 Section
15 Support Plate
16 End of the outer cup
17 Longitudinal axis
18 Folding

1-11. (canceled)

12. An absorber element with a flange plate (1) and a deformation body (2, 3, 4), being positioned between an object which is to be protected and an impact element, for absorbing energy created during an impact, and the impact element being secured by the absorber element which is, in turn, secured to the flange plate (1) and covers a hollow area of the object which needs to be protected,
an axial end (6) of the deformation body (2, 3, 4), facing away from the flange plate (1), being connectable with the impact element,
the deformation body (2, 3, 4) comprising a hollow cylindrical inner tube (2), a telescoping tube (3) with an inside-out formed section (5), and an outer cup (4) all being interlaced with one another in such a way that a section (7) of the inner tube (2), for connection with the impact element, being positioned outside of both the telescoping tube (3) and the outer cup (4),
the inner tube (2), adjacent an end which faces the flange plate (1), extends into the outer cup (4) as well as extends into an opening (8) of the telescoping tube (3) which is partially positioned in the outer cup (4) and extends into the inside-out formed section (5) of the telescoping tube (3),
the inner tube (2) being firmly bonded with the opening (8) of the telescoping tube (3) and being firmly bonded, in an area of its entry into the outer cup (4), with the outer cup (4), and
the end (16) of the outer cup (4), facing a way from the impact element, being connected at the flange plate (1) with the inside-out formed section (5) of the telescoping tube (3) extending from the outer cup (4) towards a previously mentioned end (16) of the outer cup (4).

13. The absorber element according to claim 12, further comprising that at least one of the outer cup (4) and the telescoping tube (3) extends, in cross section, conically in a direction of the a flange plate (1).

14. The absorber element according to claim 12, further comprising that the flange plate (1) is positioned between an end (16) of the outer cup (4), which faces away from the impact element, and the inside-out formed section (5) of the telescoping tube (3), the flange plate (1) is firmly connected to the output cup (4) on a side (9) which faces the impact element, and is connected firmly bonded with the telescoping tube (3) on an opposite side (10), via a rim of the inside-out formed section (5), and the telescoping tube (3), via a recess (11) of the flange plate (1), extends into the outer cup (4).

15. The absorber element according to claim 12, further comprising that the flange plate (1) is formed through the outer cup (4) and one of an end (16) and the inside-out folded section (5) of the telescoping tube (3), extends transverse with respect to a longitudinal axis (17) of the absorber element, is constructed as at least one collar (12, 13) and which extends radial outward, and the outer cup (4) and the telescoping tube (3) are firmly bonded to the at least one collar (12, 13).

16. The absorber element according to claim 12, further comprising that the inner tube (2) extends beyond the opening (8) of the telescoping tube (3) and projects into the inside-out folded section (5) into the telescoping tube (3).

17. The absorber element according to claim 16, wherein the telescoping tube (3) expands conically, in cross section, in a direction of the flange plate (1) and a section (14) of the inner tube (2) which extends into the telescoping tube (3) also conically expands.

18. The absorber element according to claim 17, further comprising that the outer surface of the inner tube (2), in the section (14) of the inner tube (2) which extends into the telescoping (3), is closely fitted adjacent an inner surface of the telescoping tube (3).

19. The absorber element according to claim 12, wherein a support plate (15) is firmly bonded with the inner tube (2), at the end (6) of the inner tube (2) which faces away from the flange plate (1), the support plate (15) extends transverse or is inclined relative to a longitudinal axis (17) of the inner tube (2) and closes the inner tube (2), and the support plate (15) facilitates connection of the inner tube (2) with the impact element.

20. The absorber element according to claim 12, further comprising that at least the inner tube (2), the telescoping tube (3) and the outer cup (4) of the absorber element are manufactured from steel.

21. The absorber element according to claim 12, further comprising that at least the inner tube (2), the telescoping tube (3) and the outer cup (4) of the absorber element are manufactured from aluminum.

22. The absorber element according to claim 12, further comprising that the firm bond between parts of the absorber element is created by welding.
